(19) United States
(12) Patent Application Publication
(10) Pub. No.: US 2010/0275885 A1
(43) Pub. Date: Nov. 4, 2010

(54) Method for Determining an Opening Voltage of a Piezoelectric Injector

(76) Inventors: Oliver Becker, Schriesheim (DE); Thomas Breitbach, Stuttgart (DE)

Correspondence Address: KENYON & KENYON LLP, ONE BROADWAY, NEW YORK, NY, 10004, US

(21) Appl. No.: 12/225,354

(22) PCT Filed: Mar. 14, 2007
(86) PCT No.: PCT/EP2007/052378

§ 371 Date: Jul. 19, 2010

(30) Foreign Application Priority Data
Mar. 22, 2006 (DE) 10 2006 013 166.5

(51) Int. Cl. F02M 51/00; G01M 15/04

(52) U.S. Cl. 123/478; 73/114.45

(57) ABSTRACT

A method for determining an opening voltage of an injector having a piezo actuator, in particular an injector of an internal combustion engine, in which an output voltage is applied at the piezo actuator in the closed state of the injector, and the voltage is lowered by energizing the piezo actuator so as to open the injector. The energy supply is interrupted at a holding voltage and the voltage change present at the piezo actuator is then measured over the time, the reaching of the opening voltage being inferred in the case of a voltage rise.

### FIELD OF THE INVENTION

The present invention relates to a method for determining an opening voltage of an injector having a piezo actuator, in particular an injector of an internal combustion engine, in which an output voltage is applied to the piezo actuator in the closed state of the injector, and the voltage is lowered by energizing the piezo actuator so as to open the injector, and it relates to a control device for implementing the method.

### BACKGROUND INFORMATION

Nozzle needles of fuel injectors (injectors) for modern diesel and Otto engines are frequently actuated directly or indirectly via piezoelectric elements (piezoelectric actuators or piezo actuators) as a result of the high dynamic specifications.

The mechanical and electric characteristics of these piezoelectric elements do not remain constant over the service life. Not only the actuator lift and the actuator capacitance but also the actuator rigidity change over the service life. Without complicated measuring technology, it is impossible to detect these changes directly during operation and thus to compensate them. This results in errors in the injected fuel quantity.

### SUMMARY OF THE INVENTION

Therefore, it is an object of the present invention to provide a method as well as a control device for implementing the method, by which the previously mentioned aging manifestations are able to be detected and compensated.

This problem is addressed by a method for determining an opening voltage of an injector having a piezo actuator, in particular an injector of an internal combustion engine, in which an output voltage is applied to the piezo actuator in the closed state of the injector, and the voltage is lowered by energizing the piezo actuator so as to open the injector; the energy supply is interrupted at a holding voltage, and the voltage change present at the piezo actuator is then measured over the time, and the reaching of the opening voltage is inferred in the case of a voltage rise.

In a further development, the holding voltage is increased from injection to injection in a stepwise manner until, following an interruption of the energy supply, the voltage rise undershoots a minimum value.

In a further development, the holding voltage is increased from injection to injection in a stepwise manner until, following an interruption of the energy supply, the voltage rise undershoots a minimum gradient.

The method is preferably implemented during regular operation of the internal combustion engine. In other words, the method requires no additional control or test devices, e.g., in a service facility, but instead is carried out using the means available in the vehicle. The method is implemented automatically by a control device in a program-controlled manner, preferably at the end of an operating period interval or at the end of a time span.

In a further development, the holding voltage of an injector is varied, and an integrator of a quantity-compensation control is monitored. In another further development, the reaching of the opening voltage is inferred when the quantity-compensation control modifies the control times and/or control voltages of the injector such that a larger injection quantity is induced.

The problem mentioned in the introduction is also solved by a control device which includes means for determining an opening voltage of an injector having a piezo actuator, in particular an injector of an internal combustion engine, in which an output voltage is applied to the piezo actuator in the closed state of the injector and the voltage is lowered by energizing the piezo actuator so as to open the injector; the energy supply is interrupted at a holding voltage and the voltage change present at the piezo actuator is then measured over the time, the reaching of the opening voltage being inferred in the case of a voltage rise.

### BRIEF DESCRIPTION OF THE DRAWINGS

FIG. 1 shows the technical environment of the present invention.

FIG. 2 shows an example of the injection quantity of a piezoelectric injector over the applied maximum voltage.

FIG. 3 shows an example of a voltage characteristic in a piezo element of a piezoelectric injector given an interruption in the energy supply.

FIG. 4 shows an enlarged illustration of region X in FIG. 3.

FIG. 5 shows a flow chart of the method.

### DETAILED DESCRIPTION

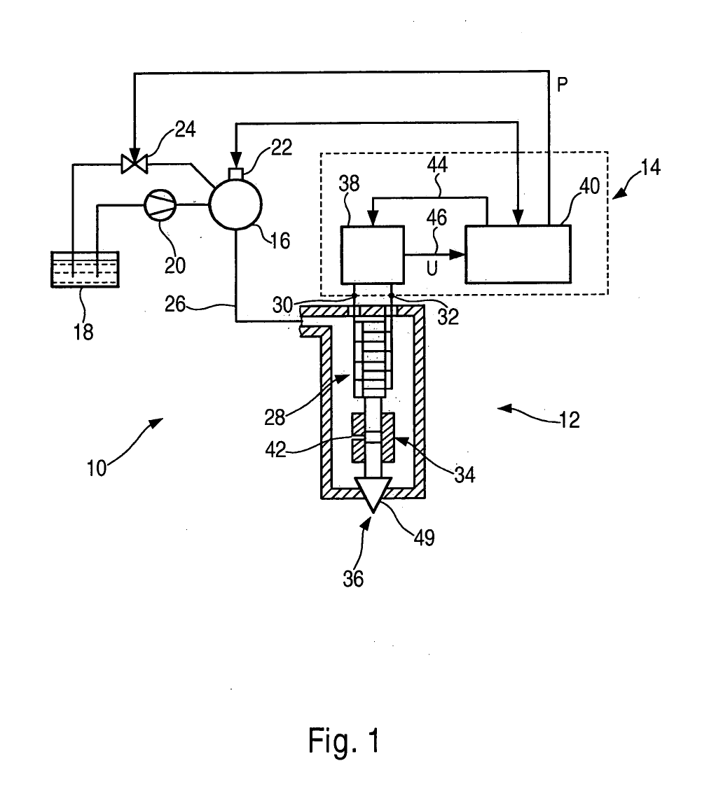

FIG. 1 shows an accumulator injection system 10, which has an injector (injection valve) 12, a control device 14, a high-pressure fuel accumulator 16, a fuel tank 18, a high-pressure pump 20, as well as a pressure sensor 22 and a pressure-regulation valve 24. Injector 12 is connected to high-pressure accumulator 16 via a high-pressure line 26, so that the pressure prevailing in its interior coincides with that inside high-pressure accumulator 16 in a static state. Disposed inside injector 12 is a piezo actuator 28, which is realized as a stack consisting of n layers of piezoelectric material, each lying between a first connection 30 and a second connection 32 electrically.

Piezo actuator 28 is connected to a nozzle needle 36 via a hydraulic coupler 34 and controlled by control device 14, which includes power and measuring electronics 38 and a control component 40 for this purpose. Coupler 34 is equipped with a throttle 42. Throttle 42 allows a slow compensation of the pressures within and outside of coupler 34, so that only rapid linear deformations of piezo actuator 28 are transmitted to nozzle needle 36, whereas slow, thermally induced changes in volume are compensated.

The control intervention in power and measuring electronics 38 is indicated by arrow 44 in FIG. 1. Arrow 46 represents a forwarding of a voltage ü, detected by power and measuring electronics 38, to control component 40. The charging and discharging of piezo actuator 28 is implemented via connections 30 and 32, respectively. Fuel pressure p in high-pressure accumulator 16 or in some other part of high-pressure accumulator injection system 10 is detected by pressure sensor 22 and forwarded to control device 14.

As shown in FIG. 1 in principle, piezo actuator 28 is acting directly on nozzle needle 36 by a change in length, via hydraulic coupler 34. Nozzle needle 36 sits firmly on its seat when piezo actuator 28 is charged and thus has expanded. The closing force is generated by the pressure in the coupler space. If piezo actuator 28 is discharged, it contracts and relieves nozzle needle 36 via hydraulic coupler 34, which is filled with fuel. The injection pressure prevailing at a pressure shoulder 49 of nozzle needle 36 permanently generates an opening force acting on nozzle needle 36. When piezo actuator 28 is discharged, the pressure in coupler 34 falls below the amount of the opening force, which causes nozzle needle 36 to lift off from its seat, thereby leading to an injection of fuel.

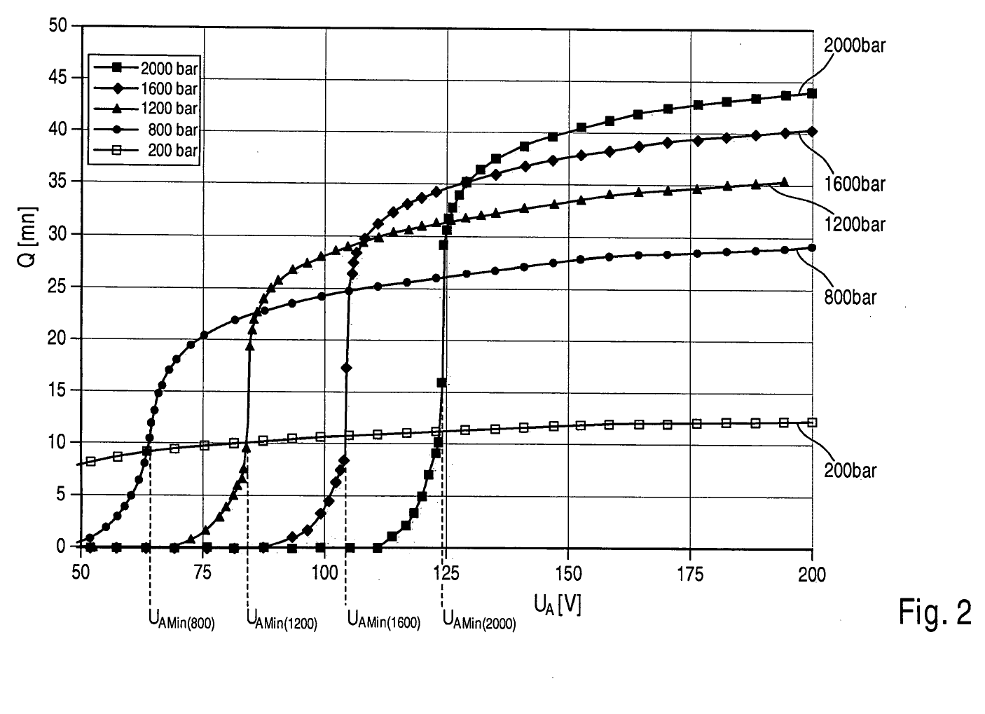

FIG. 2 shows an example of an injection quantity Q of a piezoelectric injector 12 over output voltage U_{A}, applied at piezo actuator 28. Output voltage U_{A} applied at piezo actuator 28 is plotted via the abscissa, and injection quantity Q is plotted in cubic millimeters via the ordinate. The set of curves in FIG. 2 is plotted for different rail pressures, which range from 200 to 2000 bar as indicated in the legend. It is easy to see that, starting with a specific output voltage U_{A}, a pronounced increase in injection quantity Q occurs as a function of the rail pressure. In FIG. 2 it is assumed that a voltage drop from output voltage U_{A} at the actuator to an opening voltage U_{OE} of approximately 0 Volt is taking place, i.e., that the piezo element is being discharged completely. The minimally required output voltage U_{A} at the actuator has been plotted in FIG. 2 by U_{AMin} (_{rail pressure}) in each case; that is to say, output voltage U_{A} at the piezo element minimally required for a reliable injection at an injection pressure or rail pressure of 2000 bar is denoted by U_{AMin} (₂₀₀₀). If piezo actuator 28 is therefore operated at a rail pressure of 2000 bar, i.e., an output voltage Up, of 120 Volt, for instance, then injector 12 does not open in a voltage drop to 0 Volt. In contrast, given an output voltage U_{A} of approximately 125 Volt at a rail pressure of 2000 bar, an injection quantity Q of 30 mm³, for instance, is achieved in a voltage drop to 0 Volt; in a further increase of the closing voltage, the injection quantity rises only slightly, and given a 200 Volt closing voltage and a rail pressure of 2000 bar, an injection quantity of approximately 44 mm³ is produced. Piezoelectric injector 12 is operated above voltage UA_{Min} for the individual rail pressure. Piezo actuator 28 essentially acts like a capacitor; in the closed state of the injector, an output voltage U_{A}, which amounts to 180 Volt, for example, is applied in the exemplary embodiment. To open the injector, the piezo element is discharged, a displacement current flowing in the process. In the most basic case, a switchable ohmic resistor disposed between the clamps of the piezo element can be imagined here as a substitute circuit diagram, via which the piezo element is discharged. If the switch is closed, then the piezo element discharges; if it is opened, the discharge is interrupted.

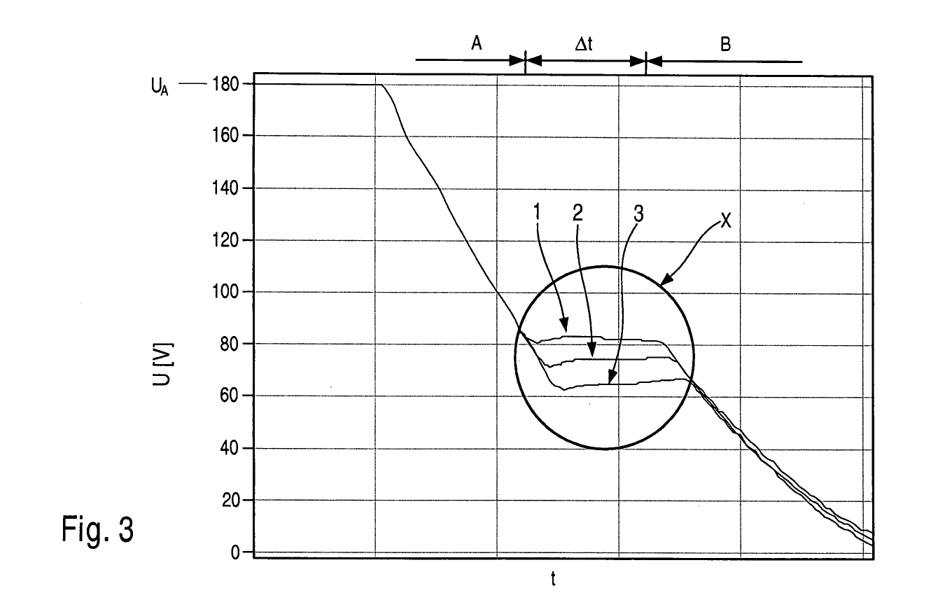

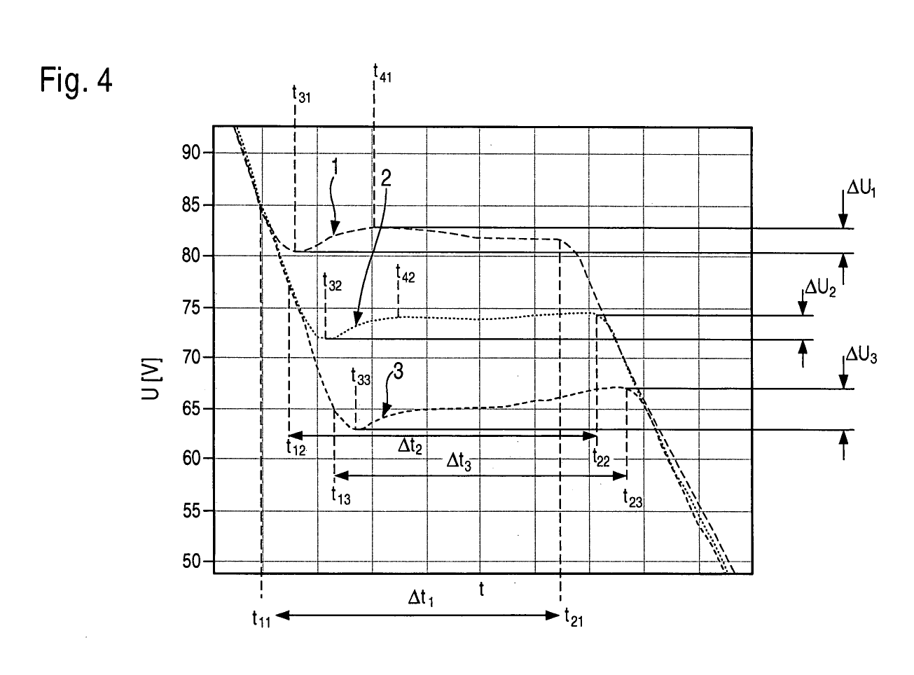

FIG. 3 shows the voltage characteristic at piezo actuator 28 in one exemplary embodiment of a method according to the present invention. In this example output voltage U_{A}=180 V. To discontinue an injection, piezo actuator 28 is discharged, a displacement current flowing in the process. FIG. 3 shows discharge curves for three charge phases; in a first discharge phase A, piezo actuator 28 is initially discharged, the discharge being interrupted at a holding voltage U_{H}. This interruption is referred to as current inflow pause Δt and lasts from instant t₁ₙ until instant T₂ₙ. Index n denotes curves 1, 2 and 3. Starting at instant t₂ₙ, the discharge is continued again in second discharge phase B. Illustrated in FIG. 3 is a set of curves for the discharge of a piezo actuator 28 down to different holding voltages U_{H1}, U_{H2} and U_{H3}. FIG. 4 shows an enlarged view of the encircled region marked by X in FIG. 3. The indices are suppressed in the following text for easier readability. The discharging of piezo actuator 28 is interrupted at a holding voltage U_{H} at time t₁, until time t₂. The time span between tᵢ and t₂ is denoted as current inflow pause Δt in this context. In FIG. 3, several voltage characteristics for different holding voltages U_{Hn} are plotted as curves 1, 2 and 3, i.e., a curve 1 for a holding voltage U_{H1}, a curve 2 for a holding voltage U_{H2}, and a curve 3 for a holding voltage U_{H3}. Times t₁, t₂ and so forth are provided with an individual index t₁ₙ, t₂ₙ, t₃ₙ, t₄ₙ, . . . , n correspinding to the index of holding voltages U_{H} as, for instance, t₁₁, t₁₂, and Δt₁ for curve 1 for holding voltage U_{H1}. Holding times Δₜₙ have been selected to be identical. After holding time Δt has ended, the piezo element is energized again, so that the voltage at piezo actuator 28 continues to drop.

FIG. 4 illustrates the voltage characteristics between times t₁ₙ and t₂ₙ. The voltage characteristic is explained in the following text on the basis of curve 1. Voltage U over piezo actuator 28 initially continues to drop following the end of the current inflow phase at instant t₁₁ up to instant t₃₁ when it reaches a local minimum; then it rises again up to an instant t₄₁. Between instant t₄₁ and the restoration of the energy supply to the piezo element at instant t₂₁, voltage U over the piezo element drops again. Voltage ΔU between the minimum value at instant t₃₁ and the maximum value at instant t₄₁ within the current-inflow pause amounts to approximately 3 Volt in this case.

If the discharge is interrupted only at holding voltage U_{H3} of approximately 65 Volt, which is the case at a time t₃₁, then the voltage initially continues to drop further up to an instant t₃₃, and then it rises again. For all intents and purposes, the rise takes place until the energy supply has been restored at energization instant t₂₃ and encompasses a voltage swing ΔU₃ of approximately 5 V. Therefore, the voltage swing is greater here than at holding voltage U_{H1} of approximately 85 Volt and has no distinct local maximum as is the case at instant t₃₁ at holding voltage U_{H1} of 85 Volt. The obvious rise in voltage U over the piezo element in the current-inflow pause at holding voltage U_{H1} of 65 V is attributable to the opening of injector 12.

The higher the voltage swing of piezo actuator 28, the greater the reduction in the loading of the needle by a pressure reduction via hydraulic coupler 34. Beginning at a certain voltage swing, the needle is lifted off the seat to such an extent that it abruptly flies up due to pressure erosion, until a force equilibrium has come about between actuator force and needle force via the rising pressure in hydraulic coupler 34. In the process, the previously expanded interconnection made up of actuator, needle and the coupling of coupler and needle is compressed again. This compression induces an electric voltage in piezo actuator 28 via the piezoelectric effect in the piezoelectric actuator, which manifests itself in discharge pause Δt.

If a voltage rise that always has positive gradient since reaching the minimum value at t₃ₙ is observed in discharge pause Δt, then injector 12 has opened. If a voltage rise above a minimum value ΔUₘᵢₙ is observed, —above a value of approximately 3 Volt in the present example of FIGS. 3 and 4—, then the opening of injector 12 may also be inferred.

An opening of injector 12 may likewise be inferred if voltage gradient ΔU/Δt reaches a minimum value. Here, the gradient may be observed shortly before the energy supply is restored again at instant t₂ₙ, for instance. If it is obviously positive, then it may be assumed that an injection has taken place. The gradient in the region just prior to reaching the local minimum at time t₃ₙ is always positive and unsuitable for this analysis.

Using the previously described method according to the present invention, it is possible during operation of the internal combustion engine to determine at which voltage level or, assuming a constant closing voltage, at which opening voltage an injector 12 opens. The method may be implemented during regular operation of the internal combustion engine by reducing the voltage level in a stepwise manner during successive injections. As soon as a negative voltage gradient is observed in discharge pause Δt (current-inflow pause), as in curve 1 of FIG. 4, for example, injector 12 has not opened. The same applies if voltage difference ΔU undershoots a threshold value ΔUₛ during the current-inflow pause; in the exemplary embodiment of FIG. 4, this threshold value is approximately 3 Volt. If the method according to the present invention is implemented in the medium engine-speed range of an internal combustion engine, then injections that were not carried out when reaching a voltage level that did not open injector 12 will have only a negligible effect on smooth running and driving comfort of the internal combustion engine. Furthermore, the method may be implemented in a time-controlled or operating-time-controlled manner at long intervals, for instance monthly or semi-annually, or after a specific number of operating hours of the internal combustion engine has been reached.

In one exemplary embodiment, to implement the method, the control voltages of individual injectors 12 may be varied during vehicle operation as previously described, and the integrators of the quantity-compensation control (QCC) be monitored in the process. The quantity-compensation control ensures an equalization of the individual cylinders, so that the individual cylinders contribute an equal share of the overall torque of the internal combustion engine, if possible, which usually amounts to equal injection quantities. Given a change in the voltage swing of an injector 12 and an attendant decrease in the injection quantity, the quantity-compensation control will modify the control times or control voltages in such a way that a larger injection quantity is induced. As soon as the integrator of injector 12 to be checked progresses in a steeply upward direction in response to a change in the voltage swing, as described previously, the critical control voltage or the critical voltage level is reached, and the injected fuel quantity decreases abruptly.

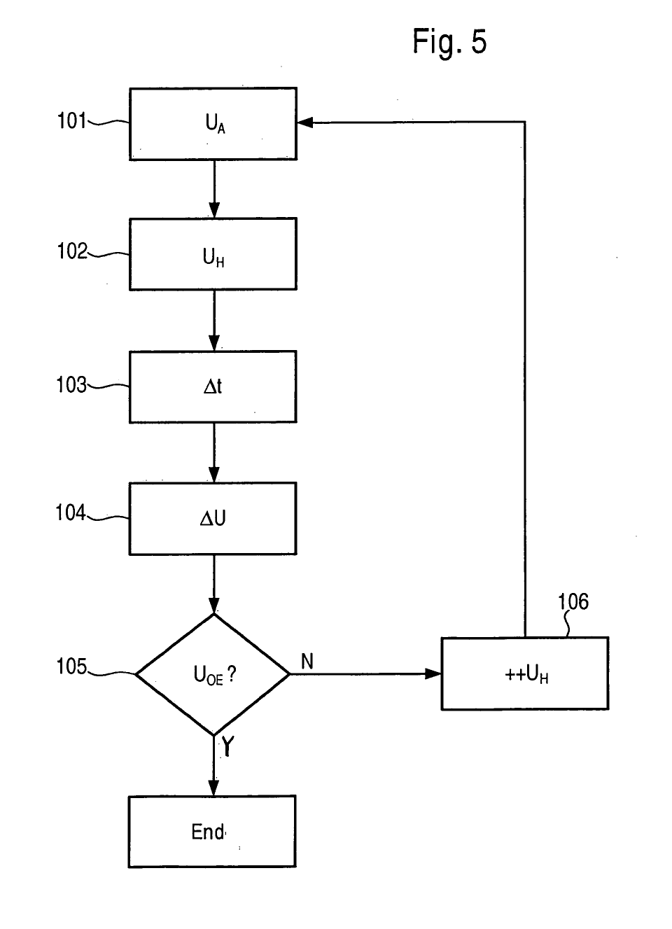

FIG. 5 shows a flow chart of the method. Given an applied output voltage U_{A}, piezo actuator 28 is energized in step 101, so that voltage U at piezo actuator 28 decreases. At holding voltage U_{H}, the energy supply of piezo actuator 28 is interrupted in step 102. In step 103, the interruption lasts for time period Δt. Voltage U applied at piezo actuator 28 is measured during time period Δt. Voltage change AU over the time is measured in the process. In step 104, voltage change ΔU is evaluated, as described above. In step 105, it is checked whether the voltage determined in this manner is the opening voltage of the injector. If this is the case, the method will be terminated in step 107 (case N); if this is not the case (Y), then branching to step 106 takes place. In step 106, holding voltage U_{H} is then increased, which is indicated here by ++U_{H}, whereupon branching back to step 101 takes place.

1-8. (canceled)

9. A method for determining an opening voltage of an injector having a piezo actuator, comprising:
applying an output voltage at the piezo actuator in a closed state of the injector;
lowering a voltage by energizing the piezo actuator so as to open the injector;
interrupting an energy supply at a holding voltage;
measuring a voltage change present at the piezo actuator over a time; and
inferring a reaching of the opening voltage in the case of a voltage rise.

10. The method according to claim 9, wherein the injector is of an internal combustion engine.

11. The method according to claim 9, further comprising increasing the holding voltage from injection to injection in a stepwise manner until the voltage rise undershoots a minimum value following an interruption of the energy supply.

12. The method according to claim 9, further comprising increasing the holding voltage from injection to injection in a stepwise manner until the voltage rise undershoots a minimum gradient following an interruption of the energy supply.

13. The method according to claim 10, wherein the method is implemented during an operation of the internal combustion engine.

14. The method according to claim 9, wherein the method is implemented after an operating time interval or a time span has elapsed.

15. The method according to claim 9, further comprising:
varying the holding voltage of the injector; and
monitoring an integrator of a quantity-compensation control.

16. The method according to claim 15, wherein the reaching of the opening voltage is inferred if the quantity-compensation control modifies control times and/or control voltages of the injector in such a way that a larger injection quantity is induced.

17. A control device for determining an opening voltage of an injector having a piezo actuator, comprising:
means for applying an output voltage at the piezo actuator in a closed state of the injector;
means for lowering a voltage by energizing the piezo actuator so as to open the injector;
means for interrupting an energy supply at a holding voltage;
means for measuring a voltage change present at the piezo actuator over a time; and
means for inferring a reaching of the opening voltage in the case of a voltage rise.

18. The control device according to claim 17, wherein the injector is of an internal combustion engine.
